(19) United States
(12) Patent Application Publication
(10) Pub. No.: US 2020/0387096 A1
(43) Pub. Date: Dec. 10, 2020

(54) HEATING DEVICE, FIXING DEVICE, AND IMAGE FORMING APPARATUS

(71) Applicants: Tomoya ADACHI, Kanagawa (JP); Yuusuke FURUICHI, Kanagawa (JP)

(72) Inventors: Tomoya ADACHI, Kanagawa (JP); Yuusuke FURUICHI, Kanagawa (JP)

(73) Assignee: Ricoh Company, Ltd., Tokyo (JP)

(21) Appl. No.: 16/860,223

(22) Filed: Apr. 28, 2020

(30) Foreign Application Priority Data
Jun. 10, 2019 (JP) 2019-108083

(51) Int. Cl. G03G 15/20; G03G 15/00

(52) U.S. Cl. CPC G03G 15/2053; G03G 15/2039; G03G 2215/2035; G03G 15/2064; G03G 15/80

(57) ABSTRACT

A heating device includes a heater, a holder configured to hold the heater, a. positioner configured to position the heater with respect to the holder in a longitudinal direction of the heater, a connector including a contact portion configured to contact an electrode of the heater. The heater includes a long base, a plurality of heat generators disposed on the base, three or more electrodes disposed on the base and electrically connected to the heat generators. The positioner is closer to the electrodes than a center position of the base in a longitudinal direction of the base.

### CROSS-REFERENCE TO RELATED APPLICATION

This patent application is based on and claims priority pursuant to 35 U.S.C. §119 to Japanese Patent Application 2019-108083, filed on Jun. 10, 2019 in the Japan Patent Office, the entire disclosure of which is hereby incorporated by reference herein.

### BACKGROUND

### Technical Field

Embodiments of the present disclosure generally relate to a heating device, a fixing device, and an image forming apparatus.

### Background Art

As a heating device used in an image forming apparatus such as a printer, there are known, for example, a fixing device that fixes toner on a sheet under heat and a drying device that dries ink on a sheet.

For example, a fixing device includes a heater that includes a resistance heat generator on a long base made of ceramic or the like. Such a heater includes electrodes on the base, and a connector as a power supply component is connected to the electrodes to supply power to the resistance heat generator.

### SUMMARY

This specification describes an improved heating device that includes a heater, a holder configured to hold the heater, a positioner configured to position the heater with respect to the holder in a longitudinal direction of the heater, and a connector including contact portions configured to contact electrodes of the heater. The heater includes a base, a plurality of heat generators disposed on the base, and three or more electrodes disposed on the base and electrically connected to the heat generators. The positioner is closer to the electrodes than a center position of the base in a longitudinal direction of the base.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic diagram illustrating a configuration of an image forming apparatus according to an embodiment of the present disclosure;

FIG. 2 is a schematic diagram illustrating a configuration of a fixing device;

FIG. 3 is a perspective view of the fixing device depicted in FIG. 2;

FIG. 4 is an exploded perspective view of the fixing device depicted in FIG. 2;

FIG. 5 is a perspective view of a heating unit incorporated in the fixing device depicted in FIG. 2;

FIG. 6 is an exploded perspective view of the heating unit depicted in FIG. 5;

FIG. 7 is a plan view of a heater;

FIG. 8 is an exploded perspective view of the heater;

FIG. 9 is a perspective view illustrating a connector connected to the heater;

FIG. 10 is an explanatory diagram illustrating an example in which at least a part of a positioner is disposed at a position corresponding to a range of an arrangement of electrodes in a longitudinal direction of the arrangement of the electrodes;

FIG. 11 is an explanatory diagram illustrating an example in which the positioner is disposed at a position corresponding to a center of the arrangement of the electrodes in a longitudinal direction of the arrangement of the electrodes;

FIG. 12 is an explanatory diagram illustrating how a heater holder interferes with a connector;

FIG. 13 is an explanatory diagram illustrating an example of a recess of a heater shifted from a passage of a contact portion of the contact terminal;

FIG. 14 is an explanatory diagram illustrating an example of the recess of the heater disposed at an edge portion over which the contact portion of the contact terminal does not pass;

FIG. 15 is an explanatory diagram illustrating an example of the recess of the heater disposed at the edge portion near a common power supply line;

FIG. 16 is an explanatory diagram illustrating an example of the recess of the heater having a curve portion;

FIG. 17 is an explanatory diagram illustrating an example of the recess of the heater having projections protruding in directions facing each other;

FIG. 18 is an explanatory diagram illustrating an example of the positioner of the heater that is a projection;

FIG. 19 is an explanatory diagram illustrating an example of the positioner of the heater that is a through hole;

FIG. 20 is an explanatory diagram illustrating an example of electrodes arranged in a short-side direction of a base;

FIG. 21 is an explanatory diagram illustrating an example of electrodes arranged in the short-side direction and a longitudinal direction of the base;

FIG. 22 is a plan view illustrating an example of the heater including four electrodes and three heat generators capable of controlling heat generation independently;

FIG. 23 is a plan view illustrating an example of the heater including the heat generators extending in the longitudinal direction of the base;

FIG. 24 is a diagram illustrating an example of the heater including heat generators connected in series;

FIG. 25 is a schematic diagram illustrating a configuration of another fixing device installable in the image forming apparatus depicted in FIG. 1;

FIG. 26 is a schematic diagram illustrating a configuration of still another fixing device installable in the image forming apparatus depicted in FIG. 1; and

FIG. 27 is a schematic diagram illustrating a configuration of still further another fixing device installable in the image forming apparatus depicted in FIG. 1.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Although the embodiments are described with technical limitations with reference to the attached drawings, such description is not intended to limit the scope of the disclosure and all of the components or elements described in the embodiments of this disclosure are not necessarily indispensable.

With reference to drawings, a description is given below of the present disclosure. In the drawings illustrating the following embodiments, the same reference numbers are allocated to elements having the same function or shape and redundant descriptions thereof are omitted below.

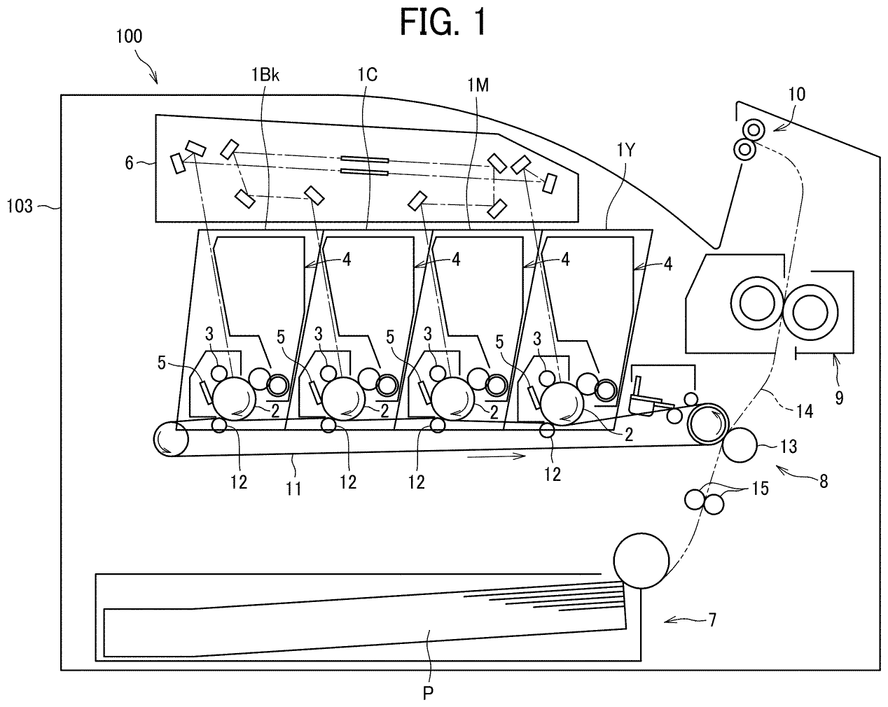

FIG. 1 is a schematic diagram illustrating a configuration of an image forming apparatus according to an embodiment of the present disclosure.

As illustrated in FIG. 1, the image forming apparatus 100 includes four image forming units 1Y, 1M, 1C, and 1Bk serving as image forming devices, respectively. The image forming units 1Y, 1M, 1C, and 1Bk are removably installed in a body 103 of the image forming apparatus 100. The image forming units 1Y, 1M, 1C, and 1Bk have a similar construction except that the image forming units 1Y, 1M, 1C, and 1Bk contain developers in different colors, that is, yellow, magenta, cyan, and black, respectively, which correspond to color separation components for a color image. Specifically, each of the image forming units 1Y, 1M, 1C, and 1Bk includes: a photoconductor 2 in a drum-like shape as an image bearer; a charger 3 to charge a surface of the photoconductor 2; a developing device 4 configured to form a toner image by supplying toner, as a developer, to a surface of the photoconductor 2; and a cleaner 5 to clean the surface of the photoconductor 2.

The image forming apparatus 100 further includes an exposure device 6 to expose the surface of each photoconductor 2 to form an electrostatic latent image, a sheet feeder 7 to supply a sheet P as a recording medium, a transfer device 8 to transfer the toner image formed on each photoconductor 2 onto the sheet P, a fixing device 9 as a heating device according the present disclosure to fix the transferred toner image onto the sheet P, and an output device 10 to eject the sheet P outside the image forming apparatus 100.

The transfer device 8 includes: an intermediate transfer belt 11 in the form of a rotatable endless belt stretched taut with multiple rollers, as an intermediate transferor; four primary transfer rollers 12 each as a primary transferor to transfer the toner image formed on each photoconductor 2 onto the intermediate transfer belt 11; and a secondary transfer roller 13 as a secondary transferor to transfer the toner image transferred onto the intermediate transfer belt 11 onto the sheet P. The primary transfer rollers 12 are in contact with the respective photoconductors 2 via the intermediate transfer belt 11. Therefore, the intermediate transfer belt 11 is in contact with the respective photoconductors 2, thus forming primary transfer nips therebetween. The secondary transfer roller 13 contacts, via the intermediate transfer belt 11, one of the plurality of rollers around which the intermediate transfer belt 11 is stretched. Thus, a secondary transfer nip is formed between the secondary transfer roller 13 and the intermediate transfer belt 11.

The image forming apparatus 100 accommodates a sheet conveyance path 14 through which the sheet P fed from the sheet feeder 7 is conveyed. A timing roller pair 15 is disposed in the sheet conveyance path 14 at a position between the sheet feeder 7 and the secondary transfer nip defined by the secondary transfer roller 13.

Referring to FIG. 1, a description is provided of printing processes performed by the image forming apparatus 100 having the construction described above.

When the image forming apparatus 100 receives an instruction to start printing, a driver drives and rotates the photoconductor 2 clockwise in FIG. 1 in each of the image forming units 1Y, 1M, 1C, and 1Bk. The charger 3 charges the surface of the photoconductor 2 uniformly at a high electric potential. Subsequently, the exposure device 6 exposes the surface of each of the photoconductors 2 based on image data created by a document scanner that reads an image on a document or print data provided by a terminal, thus decreasing the electric potential of an exposed portion on the photoconductor 2 and forming an electrostatic latent image on the photoconductor 2. The developing device 4 supplies toner to the electrostatic latent image formed on the photoconductor 2, forming a toner image thereon.

When the toner images formed on the photoconductors 2 reach the primary transfer nips defined by the primary transfer rollers 12 with the rotation of the photoconductors 2, the toner images formed on the photoconductors 2 are transferred onto the intermediate transfer belt 11 driven and rotated counterclockwise in FIG. 1 successively such that the toner images are superimposed on the intermediate transfer belt 11, forming a full color toner image thereon. Thereafter, the full color toner image formed on the intermediate transfer belt 11 is conveyed to the secondary transfer nip defined by the secondary transfer roller 13 with the rotation of the intermediate transfer belt 11 and is transferred onto a sheet P conveyed to the secondary transfer nip. The sheet P is fed from the sheet feeder 7. The timing roller pair 15 temporarily stops the sheet P fed from the sheet feeder 7 and conveys the sheet P to the secondary transfer nip, timed to coincide with the toner image on the intermediate transfer belt 11. Accordingly, the full color toner image is transferred onto and borne on the sheet P. After the toner image is transferred onto the intermediate transfer belt 11, the cleaner 5 removes residual toner remained on the photoconductor 2 therefrom.

The sheet P transferred with the full color toner image is conveyed to the fixing device 9 that fixes the full color toner image on the sheet P. Thereafter, the output device 10 ejects the sheet P onto the outside of the image forming apparatus 100, thus finishing a series of printing processes.

Next, a configuration of the fixing device 9 is described.

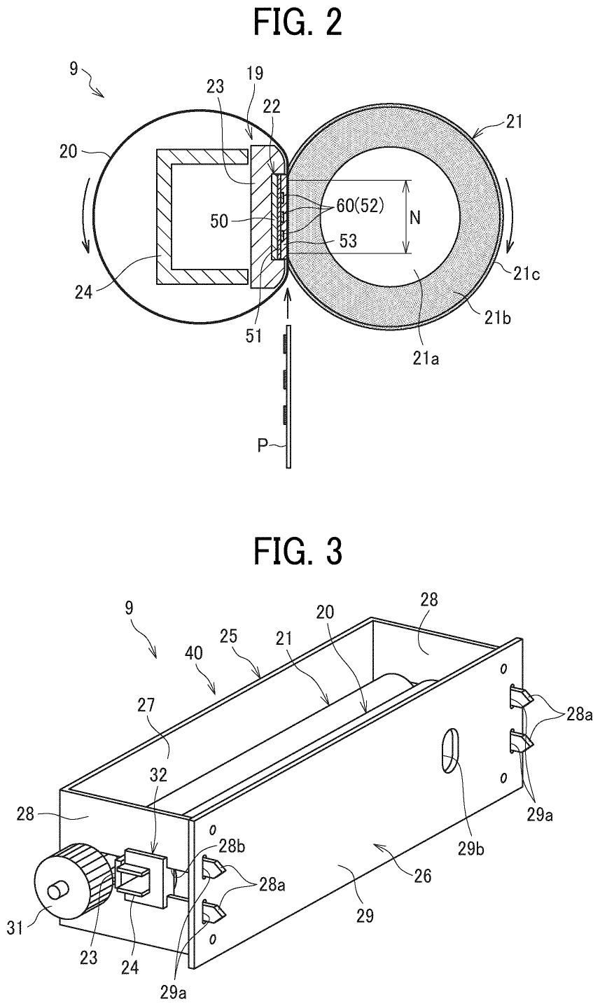

As illustrated in FIG. 2, the fixing device 9 according to the present embodiment includes a fixing belt 20 as a fixing rotator, a pressure roller 21 as an opposed rotator to contact an outer circumferential surface of the fixing belt 20 and form a nip N, and a heating unit 19 to heat the fixing belt 20, The heating unit 19 includes a heater 22, a heater holder 23, and a stay 24. The heater 22 is a laminated heater and serves as a heater or a heating member. The heater holder 23 serves as a holder that holds or supports the heater 22. The stay 24 serves as a reinforcement that reinforces the heater holder 23 throughout an entire width of the heater holder 23 in a longitudinal direction thereof.

The fixing belt 20 is formed as an endless belt and includes, for example, a tubular base made of polyimide (PI), the tubular base having an outer diameter of 25 mm and a thickness of from 40 to 120 μm. The fixing belt 20 further includes a release layer serving as an outermost surface layer, The release layer is made of fluororesin, such as tetrafluoroethylene-perfluoroalkylvinylether copolymer (PFA) and polytetrafluoroethylene (PTFE), and has a thickness in a range of from 5 μm to 50 μm to enhance durability of the fixing belt 20 and facilitate separation of the sheet P and a foreign substance from the fixing belt 20. An elastic layer made of rubber having a thickness of from 50 to 500 μm may be provided between the base and the release layer. The base of the fixing belt 20 may be made of heat resistant resin such as polyetheretherketone (PEEK) or metal such as nickel (Ni) or stainless steel (Steel Use Stainless, SUS), instead of polyimide. An inner circumferential surface of the fixing belt 20 may be coated with polyimide, PTFE, or the like to produce a slide layer.

The pressure roller 21 having, for example, an outer diameter of 25 mm, includes a solid iron cored bar 21a, an elastic layer 21b on the surface of the bar 21a, and a release layer 21c formed on the outside of the elastic layer 21b. The elastic layer 21b is made of silicone rubber and has a thickness of 3.5 mm, for example. Preferably, the release layer 21c is formed by a fluororesin layer having, for example, a thickness of approximately 40 μm on the surface of the elastic layer 21b to improve releasability.

The heater 22 extends in a longitudinal direction thereof throughout an entire width of the fixing belt 20 in a rotation axis direction of the fixing belt 20, referred to as a longitudinal direction of the fixing belt 20 below. The heater 22 contacts the inner circumferential surface of the fixing belt 20 at a position corresponding to the pressure roller 21. The heater 22 includes a planar base 50, a first insulation layer 51 disposed on the base 50, a conductor layer 52 disposed on the first insulation layer 51, and a second insulation layer 53 that covers the conductor layer 52. The conductor layer 52 includes a heat generator 60. In the present embodiment, the base 50, the first insulation layer 51, the conductor layer 52 including the heat generator 60, and the second insulation layer 53 are layered in this order toward the fixing belt 20, that is, the nip N. Heat generated from the heat generator 60 is transmitted to the fixing belt 20 via the second insulation layer 53.

Alternatively, the heat generator 60 may be disposed on a surface of the base 50 facing the heater holder 23, that is, the surface opposite to a surface of the base 50 facing the fixing belt 20. In that case, since the heat of the heat generator 60 is transmitted to the fixing belt 20 through the base 50, it is preferable that the base 50 be made of a material with high thermal conductivity such as aluminum nitride. In the heater 22 according to the present embodiment, another insulation layer may be further disposed on a surface of the base 50 facing the heater holder 23, that is, the surface opposite to the surface of the base 50 facing the fixing belt 20.

The heater 22 may not contact the fixing belt 20 or may be disposed opposite the fixing belt 20 indirectly via a low friction sheet or the like. However, the heater 22 that contacts the fixing belt 20 directly as in the present embodiment enhances conduction of heat from the heater 22 to the fixing belt 20. The heater 22 may contact the outer circumferential surface of the fixing belt 20. However, if the outer circumferential surface of the fixing belt 20 is brought into contact with the heater 22 and damaged, the fixing belt 20 may degrade quality of fixing the toner image on the sheet P. Hence, preferably, the heater 22 contacts the inner circumferential surface of the fixing belt 20.

The heater holder 23 and the stay 24 are disposed inside a loop of the fixing belt 20. The stay 24 is configured by a channeled metallic member, and both side plates of the fixing device 9 support both end portions of the stay 24. The stay 24 supports a stay side face of the heater holder 23, that faces the stay 24 and is opposite a heater side face of the heater holder 23, that faces the heater 22. Accordingly, the stay 24 retains the heater 22 and the heater holder 23 to be immune from being bent substantially by pressure from the pressure roller 21, forming the fixing nip N between the fixing belt 20 and the pressure roller 21.

The heater holder 23 is preferably made of heat-resistant material because heat from the heater 22 heats the heater holder 2.3 to a high temperature. The heater holder 23 is made of heat-resistant resin having low thermal conduction, such as a liquid crystal polymer (LCP) or polyether ether ketone (PEEK) and reduces heat transfer from the heater 22 to the heater holder 23 and provides efficient heating of the fixing belt 20.

A spring serving as a biasing member causes the fixing belt 20 and the pressure roller 21 to press against each other to form the fixing nip N between the fixing belt 20 and the pressure roller 21. As a driving force is transmitted to the pressure roller 21 from a driver disposed in the body of the image forming apparatus 100, the pressure roller 21 serves as a driving roller that drives and rotates the fixing belt 20. The fixing belt 20 is driven and rotated by the pressure roller 21 as the pressure roller 21 rotates. While the fixing belt 20 rotates, the fixing belt 20 slides over the heater 22. In order to facilitate sliding performance of the fixing belt 20, a lubricant such as oil or grease may be interposed between the heater 22 and the fixing belt 20.

When printing starts, the driver drives and rotates the pressure roller 21, and the fixing belt 20 starts rotating with the rotation of the pressure roller 21. As power is supplied to the heater 22, the heat generator 60 generates heat to heat the fixing belt 20. When the temperature of the fixing belt 20 reaches a predetermined target temperature called a fixing temperature, as illustrated in FIG. 2, the sheet P bearing an unfixed toner image is conveyed to the nip N between the fixing belt 20 and the pressure roller 21, and the unfixed toner image is heated and pressed onto the sheet P and fixed thereon.

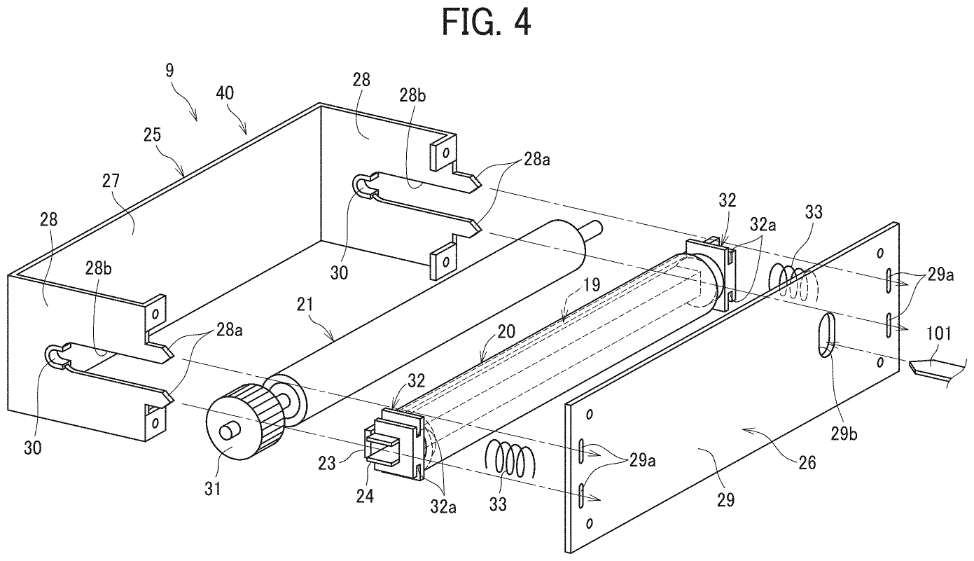

FIG. 3 is a perspective view of the fixing device 9. FIG. 4 is an exploded perspective view of the fixing device 9.

As illustrated in FIGS. 3 and 4, the fixing device 9 includes a device frame 40 that includes a first device frame 25 and a second device frame 26. The first device frame 25 includes a pair of side walls 28 and a front wall 27. The second device frame 26 includes a rear wall 29. The side walls 28 are disposed at one side and another side of the fixing belt 20, respectively, in the longitudinal direction of the fixing belt 20. The side walls 28 support both sides of each of the pressure roller 21 and the heating unit 19, respectively. Each of the side walls 28 includes a plurality of engaging projections 28a, As the engaging projections 28a engage corresponding engaging holes 29a in the rear wall 29, the first device frame 25 is coupled to the second device frame 26.

Each of the side walls 28 includes a slot 28b through which a rotation shaft and the like of the pressure roller 21 are inserted. The slot 28b opens toward the rear wall 29 and closes at a portion opposite the rear wall 29, and the portion of the slot 28b opposite the rear wall 29 serves as a contact portion. A bearing 30 that supports the rotation shaft of the pressure roller 21 is disposed at an end of the contact portion. As both sides of the rotation shaft of the pressure roller 21 are attached to the corresponding bearings 30, the side walls 28 rotatably support the pressure roller 21.

A driving force transmission gear 31 serving as a driving force transmitter is disposed at one side of the rotation shaft of the pressure roller 21 in an axial direction thereof. In a state in which the side walls 2.8 support the pressure roller 21, the driving force transmission gear 31 is exposed outside the side wall 28. Accordingly, when the fixing device 9 is installed in the body of the image forming apparatus 100, the driving force transmission gear 31 is coupled to a gear disposed inside the body of the image forming apparatus 100 so that the driving force transmission gear 31 transmits the driving force from the driver. Alternatively, a driving force transmitter to transmit the driving force to the pressure roller 21 may be pulleys over which a driving force transmission belt is stretched taut, a coupler, and the like instead of the driving force transmission gear 31.

A pair of supports 32 that supports the fixing belt 20, the heater holder 23, the stay 24, and the like is disposed at both sides of the heating unit 19 in a longitudinal direction thereof, respectively. Each support 32 has guide grooves 32a. As edges of the slot 28b of the side wall 28 enter the guide grooves 32a, respectively, the support 32 is attached to the side wall 28.

A pair of springs 33 serving as a pair of biasing members is interposed between each of the supports 32 and the rear wall 29. As the springs 33 bias the supports 32 and the stay 24 toward the pressure roller 21, respectively, the fixing belt 20 is pressed against the pressure roller 21 to form the fixing nip between the fixing belt 20 and the pressure roller 21.

As illustrated in FIG. 4, a hole 29b is disposed near one end of the rear wall 29 of the second device frame 26. The hole 29b serves as a positioner of the fixing device 9 that positions the body of the fixing device 9 with respect to the body of the image forming apparatus 100. Similarly, the body of the image forming apparatus 100 includes a projection 101 as a positioner fixed on the image forming apparatus 100. The projection 101 is inserted into the hole 29b of the fixing device 9, Accordingly, the projection 101 engages the hole 29b, positioning the body of the fixing device 9 with respect to the body of the image forming apparatus 100 in the longitudinal direction of the fixing belt 20. Note that although the hole 29b serving as the positioner is disposed at one side of the rear wall 29 in the longitudinal direction of the second device frame 26, a positioner is not disposed at another side of the rear wall 29. Thus, the second device frame 26 does not restrict thermal expansion and shrinkage of the body of the fixing device 9 in the longitudinal direction of the fixing belt 20 due to temperature change.

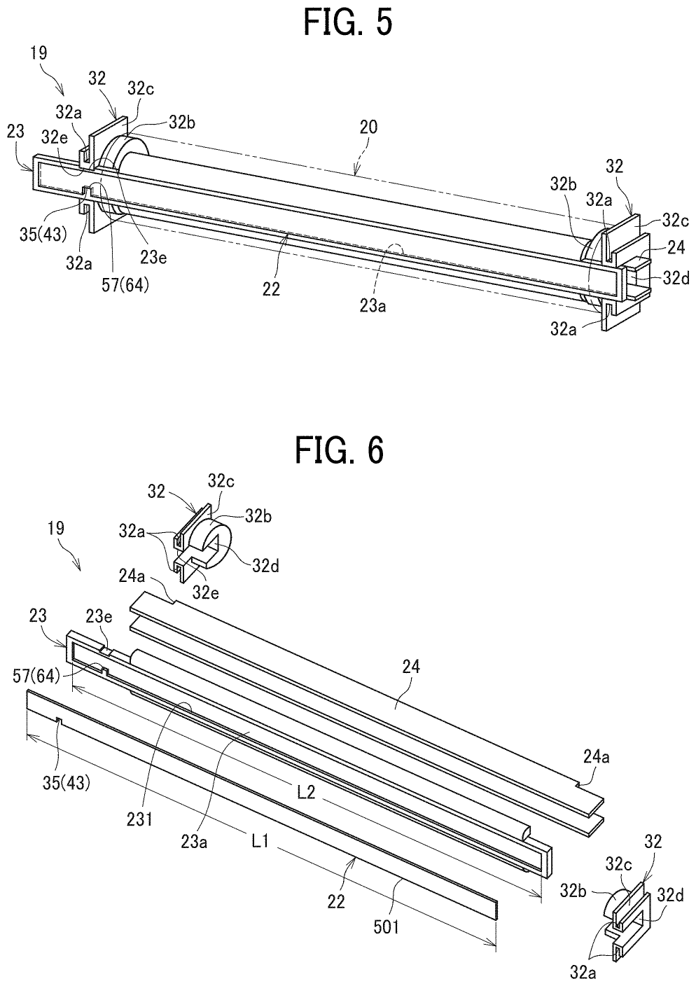

FIG. 5 is a perspective view of the heating unit 19. FIG. 6 is an exploded perspective view of the heating unit 19.

As illustrated in FIGS. 5 and 6, the heater holder 23 includes an accommodating recess 23a disposed on a belt side face of the heater holder 23, that is a face in front side of FIGS. 5 and 6. The accommodating recess 23a is rectangular and accommodates the heater 22. The accommodating recess 23a has a similar shape and size of the heater 22, but a length L2 of the accommodating recess 23a in the longitudinal direction of the heater holder 23 is set slightly longer than a length L1 of the heater 22 in the longitudinal direction of the heater 22. The accommodating recess 23a formed slightly longer than the heater 22 does not interfere the heater 22 even when the heater 22 expands in the longitudinal direction due to thermal expansion. The accommodating recess 23a accommodates the heater 22, and a connector as power supplying member described below sandwiches the heater 22 and the heater holder 23, thus the heater 22 is held in place.

In addition to the guide grooves 32a described above, each of the pair of supports 32 includes a belt support 32b, a belt restrictor 32c, and a supporting recess 32d. The belt support 32b is C-shaped and inserted into the loop of the fixing belt 20, thus contacting the inner circumferential surface of the fixing belt 20 to support the fixing belt 20. The belt restrictor 32c is a flange that contacts an edge face of the fixing belt 20 to restrict motion (e.g., skew) of the fixing belt 20 in the longitudinal direction of the fixing belt 20. The supporting recess 32d is inserted with a lateral end of each of the heater holder 23 and the stay 24 in the longitudinal direction thereof, thus supporting the heater holder 23 and the stay 24. The belt supports 32b inserted into the inner periphery of the fixing belt 20 in both ends support the fixing belt 20 in a state in which the fixing belt 20 is not tensioned in a circumferential direction thereof while the fixing belt 20 does not rotate, that is, by a free belt system.

As illustrated in FIGS. 5 and 6, the heater holder 23 includes a positioning recess 23e as a positioner disposed at one side of the heater holder 23 in the longitudinal direction thereof. The support 32 further includes an engagement 32e illustrated in a left part in FIGS. 5 and 6. The engagement 32e engages the positioning recess 23e, positioning the heater holder 23 with respect to the support 32 in the longitudinal direction of the fixing belt 20. The support 32 illustrated in a right part in FIGS. 5 and 6 does not include the engagement 32e and therefore the heater holder 23 is not positioned with respect to the support 32 in the longitudinal direction of the fixing belt 20. Positioning the heater holder 23 with respect to the support 32 at one side of the heater holder 23 in the longitudinal direction of the fixing belt 20 does not restrict an expansion and contraction of the heater holder 23 in the longitudinal direction of the fixing belt 20 due to a temperature change.

As illustrated in FIG. 6, the stay 24 includes step portions 24a at both ends in the longitudinal direction of the stay 24 to set the stay 24 on the supports 32. Each step portion 24a abuts the support 32 to restrict movement of the stay 24 in the longitudinal direction with respect to the support 32. However, at least one of the step portions 24a is configured to fit loosely, with a certain amount of play between it and the support 32 to enable expansion and contraction of the stay 24 in the longitudinal direction of the fixing belt 20 due to temperature change.

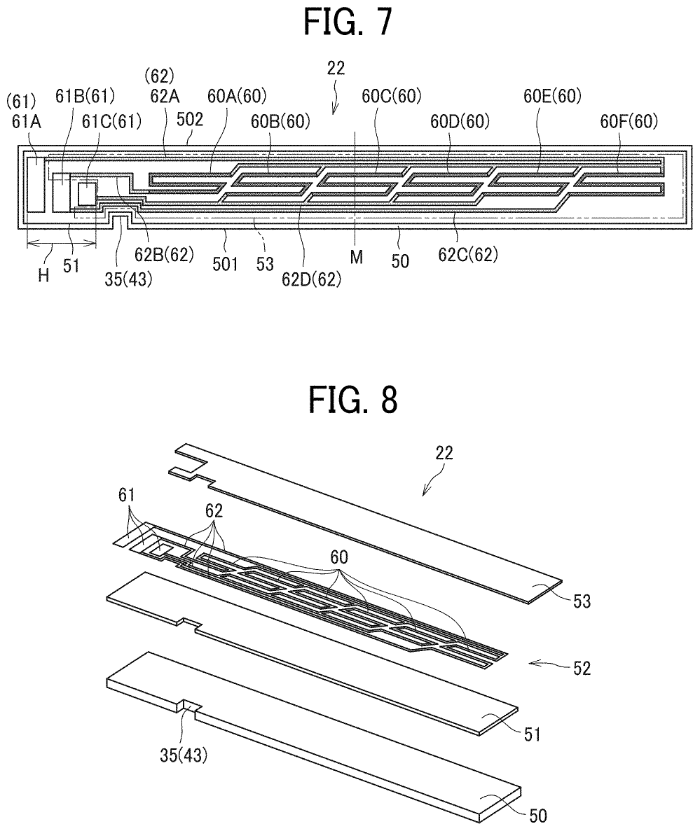

FIG. 7 is a plan view of the heater 22. FIG. 8 is an exploded perspective view of the heater 22.

As illustrated in FIG. 8, the heater 22 includes a base 50, a first insulation layer 51 disposed on the base 50, a conductor layer 52 disposed on the first insulation layer 51, and a second insulation layer 53 that covers the conductor layer 52.

The base 50 is a long plate made of a metal such as stainless steel (Steel Use Stainless, SUS), iron, or aluminum. Alternatively, the base 50 may be made of ceramic, glass, etc. If the base 50 is made of an insulating material such as ceramic, the first insulation layer 51 sandwiched between the base 50 and the conductor layer 52 may be omitted. Since metal has an excellent durability when it is rapidly heated and is processed readily, metal is preferably used to reduce manufacturing costs. Among metals, aluminum and copper are preferable because aluminum and copper have high thermal conductivity and are less likely to cause uneven temperature. Stainless steel is advantageous because stainless steel is manufactured at reduced costs compared to aluminum and copper.

The first insulation layer 51 and the second insulation layer 53 are made of material having electrical insulation, such as heat-resistant glass. Alternatively, each of the first insulation layer 51 and the second insulation layer 53 may be made of ceramic, polyimide (PI), or the like.

The conductor layer 52 includes laminated resistive heat generators 60, electrodes 61, and power supply lines 62 each of which electrically connects the electrode 61 to the heat generators 60. In the present embodiment, six heat generators 60 are disposed on the base 50. Each of the heat generators 60 is electrically connected to any two of the three electrodes 61 via a plurality of power supply lines 62 disposed on the base 50.

In FIG. 7, the three electrodes 61 are referred to as a first electrode 61A, a second electrode 61B, and a third electrode 61C in order from the left side in FIG. 7. The first electrode 61A is a common electrode connected to all heat generators 60 via a common power supply line 62A. The second electrode 61B is connected in parallel to the heat generators 60A and 60F disposed at both ends of the six heat generators 60A to 60F arranged in the longitudinal direction of the base 50 via power supply lines 62B and 62C. The third electrode 61C is connected in parallel to the heat generators 60B to 60E other than the heat generators 60A and 60F disposed at both ends via a power supply line 62D.

In the heater 22 according to the present embodiment, the heat generators 60A and 60F disposed at both ends and the other heat generators 60B to 60E disposed therebetween are individually controlled to generate heat. Specifically, a voltage applied to the first electrode 61A and the second electrode 61B causes the heat generators 60A and 60F at both ends to generate heat, and a voltage applied to the first electrode 61A and the third electrode 61C causes heat generators 60B to 60E other than the heat generators 60A and 60F at both ends to generate heat. Further, a voltage applied to all electrodes 61A to 61C causes all heat generators 60A to 60F to generate heat. For example, when the toner image is fixed on the sheet having a small size such as a size equal to or smaller than A4 size in which a sheet conveyance span is 210 mm, the heat generators 60B to 60E other than the heat generators 60A and 60F at both ends generate heat, and when the toner image is fixed on the sheet having a large size such as a size equal to or larger than A3 size in which the sheet conveyance span is 297 mm, all the heat generators 60A to 60F generate heat. As a result, the heater 22 can generate heat in a heat generation area corresponding to the sheet conveyance span.

The heat generators 60 are produced by mixing silver-palladium (AgPd), glass powder, and the like into a paste. The paste is coated on the base 50 by screen printing or the like. Thereafter, the base 50 is fired to form the heat generators 60. Alternatively, the heat generator 60 may be made of a resistive material such as a silver alloy (AgPt) and ruthenium oxide (RuO2).

The power supply lines 62 are made of a conductor having an electrical resistance lower than that of the heat generators 60. Silver (AO, silver palladium (AgPd) or the like may be used as a material of the power supply lines 62 or the electrodes 61. Screen-printing such a material forms the power supply lines 62 or the electrodes 61.

In the present embodiments, the heat generators 60, the electrodes 61, and the power supply lines 62 are made of an alloy of silver, palladium, or the like to attain a positive temperature coefficient (PTC) property. PTC defines a property in which the resistance value increases as the temperature increases. Therefore, for example, a heater output decreases under a given voltage when the temperature increases. PTC heat generators 60 start quickly with an increased output at low temperatures and prevents overheating with a decreased output at high temperatures. For example, if a temperature coefficient of resistance (TCR) of the PTC is in a range of from about 300 ppm/° C. to about 4,000 ppm/° C., the heater 22 is manufactured at reduced costs while retaining a resistance required for the heater 22. The TCR is preferably in a range of from about 500 ppm/° C. to about 2,000 ppm/° C.

As illustrated in FIG. 7, at least a part of each of the electrodes 61 is not coated by the second insulation layer 53 and is exposed so that the electrodes 61 are connected to the connector described below.

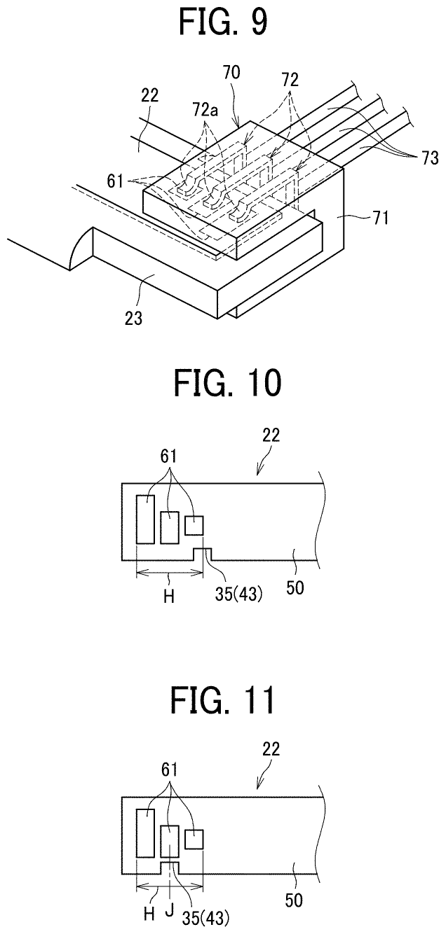

FIG. 9 is a perspective view illustrating the connector 70 connected to the heater 22.

As illustrated in FIG. 9, the connector 70 includes a housing 71 made of resin and a plurality of contact terminals 72 fixed to the housing 71. Each contact terminal 72 is configured by a flat spring and connected to a power supply harness 73.

As illustrated in FIG. 9, the connector 70 is attached to the heater 22 and the heater holder 23 such that the connector 70 sandwiches the heater 22 and the heater holder 23 together at the front side and the back side, respectively. Thus, the contact portions 72a disposed at ends of the contact terminals 72 elastically contact and press against the electrodes 61 each corresponding to the contact terminals 72, and the heat generators 60 are electrically connected to the power supply provided in the image forming apparatus via the connector 70. The above-described configuration enables the power supply to supply power to the heat generators 60. In addition, to prevent a positional deviation of the connector 70 with respect to the heater holder 23, the connector 70 is positioned by a positioner including a recess and a projection that engage each other and are disposed in the connector 70 and the heater holder 23.

In the above-described heater including the resistance heat generator, when the resistance heat generator generates heat and heats the base, the base expands due to thermal expansion and contracts due to a subsequent decrease in temperature. The thermal expansion and thermal contraction cause the electrodes to move and slide with respect to the connector, which may cause abrasion at a contact part between the electrode and the connector. Especially, in the image forming apparatus 100 according to the present embodiment that can use the sheet having A3 size or more, the length of the heater 22 in the longitudinal direction becomes a length corresponding to such a large sheet width. The base of such a long heater has a large amount of the thermal expansion and thermal contraction due to temperature change, which may increase the abrasion in the electrode or the connector.

In addition, as in the present embodiment, using metal that thermally expands larger than ceramic as a material of the base of the heater or using the heat generator having the PTC characteristic increases the amount of the thermal expansion and thermal contraction in the base. When the end portion of the sheet passes over a part of the PTC heat generator in which a current flows in the longitudinal direction of the heater, the resistance value of a part of the PTC heat generator over which the sheet does not pass increases, but the increase in the resistance value does not significantly affect the current flowing through the PTC heat generator. As a result, excessive heat is generated in the part of the PTC heat generator over which the sheet does not pass, and the amount of the thermal expansion and thermal contraction of the base may increase to an undesirable extent.

Therefore, in the present embodiment, the following measures are taken to decrease abrasion at the contact part between the electrode and the connector due to the thermal expansion and thermal contraction in the base.

As illustrated in FIG. 6, the heater 22 in the present embodiment has a positioner 35 to position the heater 22 in the longitudinal direction thereof. The positioner 35 includes a recess 43 disposed at an edge portion 501 extending in the longitudinal direction of the base 50. On the other hand, the heater holder 23 includes a projection 64 as a positioner 57 that fits with the recess 43, that is, the positioner 35 of the heater 22. The projection 64 protrudes from a side wall surface 231 extending in the longitudinal direction of the accommodating recess 23a that accommodates the heater 22. When the accommodating recess 23a of the heater holder 23 accommodates the heater 22, the projection 64 that is the positioner 57 of the heater holder 23 fits into the recess 43 that is the positioner 35 of the heater 22 to position the heater 22 in the longitudinal direction with respect to the heater holder 23.

Even when the base 50 expands due to the thermal expansion caused by the heat generation of the heat generator 60 and contracts due to the subsequent decrease in temperature, the positioner 35 positions the heater 22 in the longitudinal direction. That is, the thermal expansion and thermal contraction in the base 50 does not move the positioner 35. Considering the above-described point, in the present embodiment, to reduce the variations in the positions of the electrodes 61 due to the thermal expansion and thermal contraction of the base 50, the positioner 35 is arranged so that the positioner 35 is nearer to all electrodes 61 than the center position M of the base 50 in the longitudinal direction as illustrated in FIG. 7.

In other words, disposing all the electrodes 61 on the same side as the positioner 35 with respect to the center position M reduces the variation in the position of each electrode 61 caused by the expansion and contraction in the base 50 due to the temperature change. That is, arranging the electrodes 61 near the positioner 35 that does not move due to the temperature change can reduce the effect of the variations in the positions of electrodes 61 caused by the expansion and contraction of the base 50, that is, reduce the variations in the positions of each electrodes 61. The above-describe configuration in the present embodiment can reduce the slide at the contact part between the electrode 61 and the connector 70 and the abrasion in the electrode 61 or the connector 70.

Although the positioner 35 of the heater 22 that is the recess 43 in the above-described embodiment is outside a range H in which the electrodes 61 are aligned in the longitudinal direction as illustrated in FIG. 7, as in an example illustrated in FIG. 10, it is preferable that at least a part of the positioner 35 is inside the range H to efficiently reduce the variations in the positions of the electrodes 61 caused by the thermal expansion and the thermal contraction in the base 50. The range H in which the electrodes 61 are aligned in the longitudinal direction means a continuous range including all electrodes 61 aligning in the longitudinal direction of the base 50, that is, from an outer edge of one of electrodes 61 located at one end in the longitudinal direction of the base 50 to the other outer edge of the other electrode 61 located at the other end in the longitudinal direction of the base 50. Therefore, arranging the positioner 35 at the position in the range H in which the electrodes 61 are aligned in the longitudinal direction includes arranging the positioner 35 at a position corresponding to a position between the electrodes 61 adjacent to each other in the longitudinal direction.

A distance between the positioner 35 and each of the electrodes 61 in the longitudinal direction in the example illustrated in FIG. 10 is much shorter than a distance between the positioner 35 and each of the electrodes 61 in the longitudinal direction in the example illustrated in FIG. 7. Therefore, the configuration illustrated in FIG. 10 can further reduce the effect of the variations in the positions of electrodes 61 caused by the expansion and contraction of the base 50, that is, effectively reduce the variations in the positions of electrodes 61. Of course, the entire positioner 35 may be arranged within a range corresponding to the range H in which the electrodes 61 are aligned.

Alternatively, as in the example illustrated in FIG. 11, arranging the positioner 35 at a position corresponding to a center position J in the range H in which the electrodes 61 are aligned in the longitudinal direction can minimize a distance from the positioner 35 to the electrode 61 furthest away from the positioner 35 in the longitudinal direction. The above-described configuration can more effectively reduce the variations in the positions of the electrodes 61.

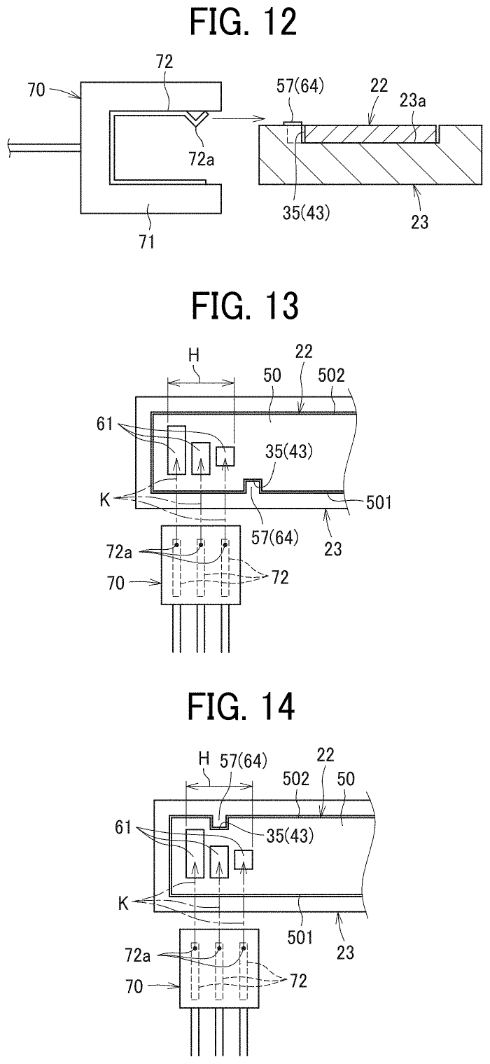

Preferably, the projection 64 of the heater holder 23 is formed on the same surface as the surface of the heater holder 23 facing the fixing belt so as not to interfere with the contact terminals 72, in particular, the contact portions 72a of the contact terminals 72 when the connector 70 is attached to and detached from the heater 22. However, as illustrated in FIG. 12, the thickness of the projection 64 may be made largely so that the projection 64 protrudes from the surface of the heater holder 23 facing the fixing belt that is the upper surface of the heater holder 23 in FIG. 12 in order to more reliably position the projection 64 and improve the workability of assembling the heater 22 to the heater holder 23.

In such a case, as illustrated in FIG. 13, in order to avoid interference between the projection 64 and the contact portions 72a of the contact terminals 72, the projection 64 of the heater holder 23 is preferably arranged at a position that does not overlap with a passage K on the base 50 over which the contact portions 72a of the contact terminals 72 pass when the connector 70 is attached to or detached from the heater 22. In the above-described configuration, corresponding to the position of the projection 64 of the heater holder 23 that does not overlap the passage K of the contact portions 72a, the recess 43 of the heater 22 is arranged at a position that shifts from the passage K of the contact portions 72a in the longitudinal direction of the base 50. The above-described configuration can avoid interference between the contact terminals 72 (that is, contact portions 72a) and the projection 64 of the heater holder 23 when the connector 70 is attached to or detached from the heater 22.

As another method for avoiding interference between the projection 64 and the contact terminals 72, as illustrated in FIG. 14, the recess 43 of the heater 22 may be formed in an edge portion 502. The edge portion 502 is one of a pair of edge portions 501, 502 that extend in the longitudinal direction of the base 50 to hold the heat generators 60 and the electrodes 61, and the contact portions 72a of the contact terminals do not pass over the edge portion 502. In the above-described configuration, corresponding to the recess 43 of the heater 22, the projection 64 of the heater holder 23 is also arranged at a position not overlapping the passage K over which the contact portions 72a pass, Therefore, the above-described configuration can avoid interference between the contact terminals 72 (that is, contact portions 72a) and the projection 64. Moreover, the above-described configuration can arrange at least a part of the recess 43 of the heater 22 at a position within the range corresponding to the range H in which the electrodes 61 are aligned in the longitudinal direction, which can effectively reduce the variations in the positions of the electrodes 61 caused by the expansion and contraction of the base 50.

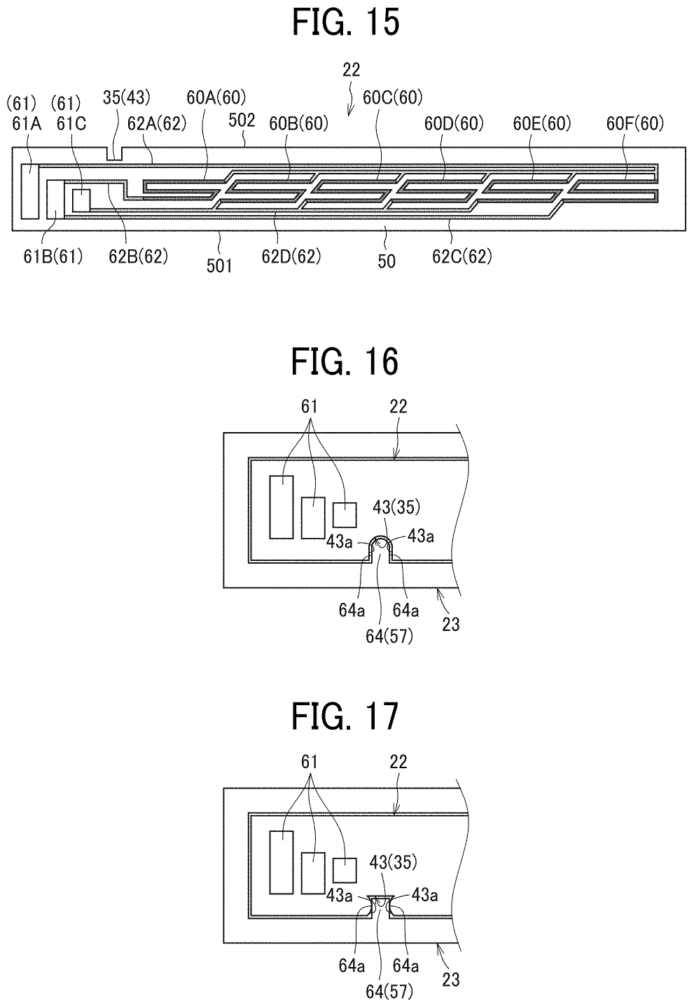

As described above, the recess 43 of the heater 22 may be disposed at any one of the pair of edge portions 501 and 502 extending in the longitudinal direction of the base 50. However, preferably, as illustrated in FIG. 7, the recess 43 is formed at the edge portion 501 that is farther from a common power supply line 62A connected to a first electrode 61A as a common electrode to reduce the size of the heater 22 in a short-side direction of the heater 22. The above-described power supply line 62A is located along the edge portion of the base 50 when components are generally laid out on the base 50. Therefore, as illustrated in FIG. 15, when the recess 43 is disposed at the edge portion 502 that is near the common power supply line 62A, the base 50 needs to be designed larger in the short-side direction that is a direction intersecting the longitudinal direction of the base 50 and the direction along a surface on which the heat generator 60 is disposed because space to locate the recess 43 is needed to avoid an interference between the common power supply line 62A and the recess 43. On the other hand, as illustrated in FIG. 7, the recess 43 disposed at the edge portion 501 farther from the common power supply line 62A does not interfere the common power supply line 62A. Therefore, the arrangement of the heat generator 60, the electrodes 61, and power supply lines 62 is easy and provides the advantage of reducing the size of the heater 22 in the short-side direction.

In the above-described embodiment, as illustrated in FIG. 7, the heater 22 has six heat generators 60A to 60F, and the heat generators 60A and 60F at both ends are connected to the common second electrode 61B that is different from a common electrode connected to the other heat generators 60B to 60E disposed between the heat generators 60A and 60F. Connecting the heat generators 60A and 60F at both ends to only one of the electrodes (that is, the second electrode 61B) and not to different electrodes can reduce a number of the electrodes and reduce the size of the heater 22.

In the above-described examples, the recess 43 and the projection 64 as the positioners 35 and 57 of the heater 22 and the heater holder 23 are both formed in a rectangular shape including a square shape, but shapes of the positioners 35 and 57 may be changed as appropriate.

For example, as illustrated in FIG. 16, the shapes of the recess 43 and the projection 64 as the positioners 35 and 57 may include a curve. Similar to the above-described examples, two facing surfaces 43a facing each other in the recess 43 and two side surfaces 64a of the projection 64 that fit the two surfaces 43a are surfaces orthogonal to the longitudinal direction of the base 50 that can effectively position the heater 22 in the longitudinal direction.

Alternatively, as illustrated in FIG. 17, the facing surfaces 43a in the recess 43 may be projections. In this case, tops of the projections that are the facing surfaces 43a in the recess 43 contact the side surfaces 64a in the projection 64 of the heater holder 23 to position the heater 22 in the longitudinal direction.

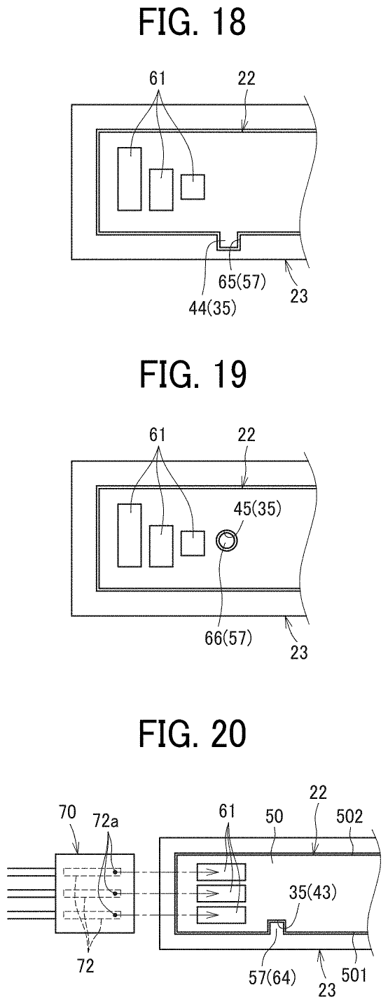

Alternatively, as illustrated in FIG. 18, the positioner 35 of the heater 22 may be formed as a projection 44 instead of the recess 43 as described above, and the positioner 57 of the heater holder 23 may be formed as a recess 65 that fits the projection 44 of the heater 22.

Alternatively, as illustrated in FIG. 19, the positioner 35 of the heater 22 may be formed as a through hole 45 penetrating the base 50 in a thickness direction of the base 50 that is a direction intersecting the longitudinal direction and the short-side direction. In this case, the projection 66 as the positioner 57 disposed on the heater holder 23 is inserted into the through hole 45 of the heater 22 to position the heater 22 in the longitudinal direction.

In the above-described example, as illustrated in FIGS. 13 and 14, the connector 70 can be attached to or detached from, in the short-side direction of the base 50, the electrodes 61 aligned in the longitudinal direction of the base 50, but the arrangement of the electrodes 61 and a direction in which the connector 70 is attached to or detached from the electrodes 61 may be changed as appropriate.

For example, as illustrated in FIG. 20, the electrodes 61 may be aligned in the short-side direction of the base 50, and the connector 70 may be detachable in the longitudinal direction of the base 50.

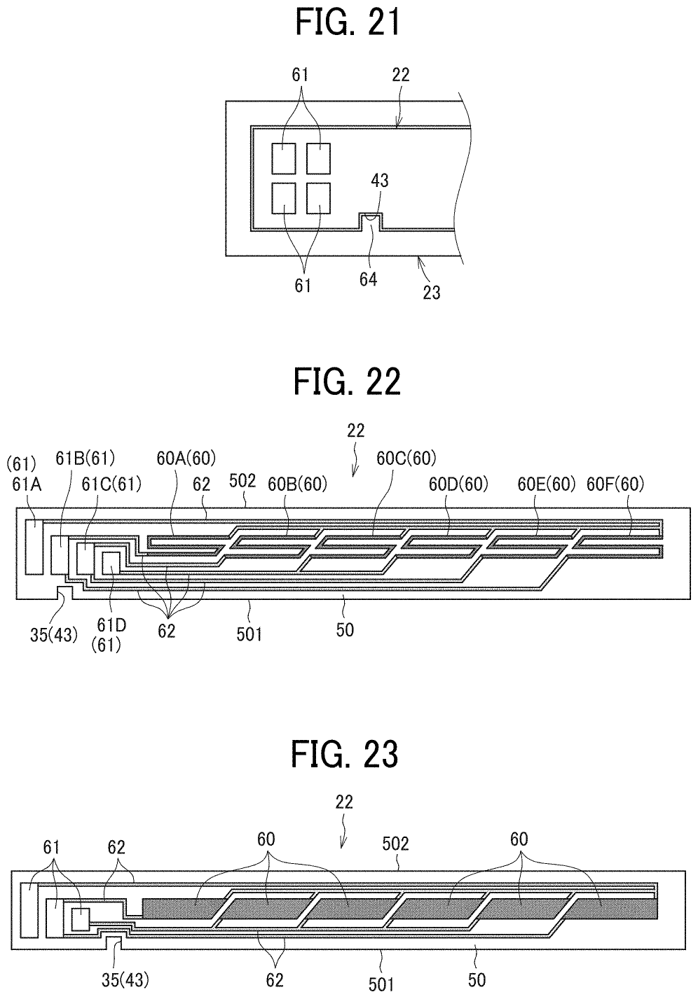

Alternatively, as illustrated in FIG. 21, the electrodes 61 may be aligned in both the longitudinal direction and the short-side direction of the base 50.

FIG. 22 illustrates an example of the heater 22 including an increased number of electrodes 61 and an increased number of groups of the heat generators 60 capable of controlling heat generation independently. In this example, the heater 22 includes four electrodes 61 and three groups of the heat generators 60 capable of controlling heat generation independently. When a voltage is applied across the first electrode 61A and the second electrode 61B among the four electrodes 61A to 61D illustrated in FIG. 22, only the heat generators 60A and 60F at both ends generate heat. When the voltage is applied across the first electrode 61A and a third electrode 61C among the four electrodes 61A to 61D, only the heat generator 60B and 60E which are located adjacent to the heat generators 60A and 60F at both ends and sandwiched by them generate heat. In addition, when the voltage is applied across the first electrode 61A and the fourth electrode 61D, only the center heat generators 60C and 60D which are located adjacent to each other generate heat. Increasing a number of the electrodes 61 and increasing a number of the groups of the heat generators 60 capable of controlling the heat generation independently as described above enables various kinds of combination of heat generation areas that can heat the sheets having a lot of widths. Alternatively, the heater 22 may include five or more electrodes 61 and four or more groups of the heat generators 60 capable of controlling heat generation independently.

The shape of the heat generators 60 is not limited to a zigzag pattern as illustrated in FIG. 7 and other drawings and may instead be a straight-line pattern extending in the longitudinal direction of the base 50 without the zigzag pattern as illustrated in FIG. 23.

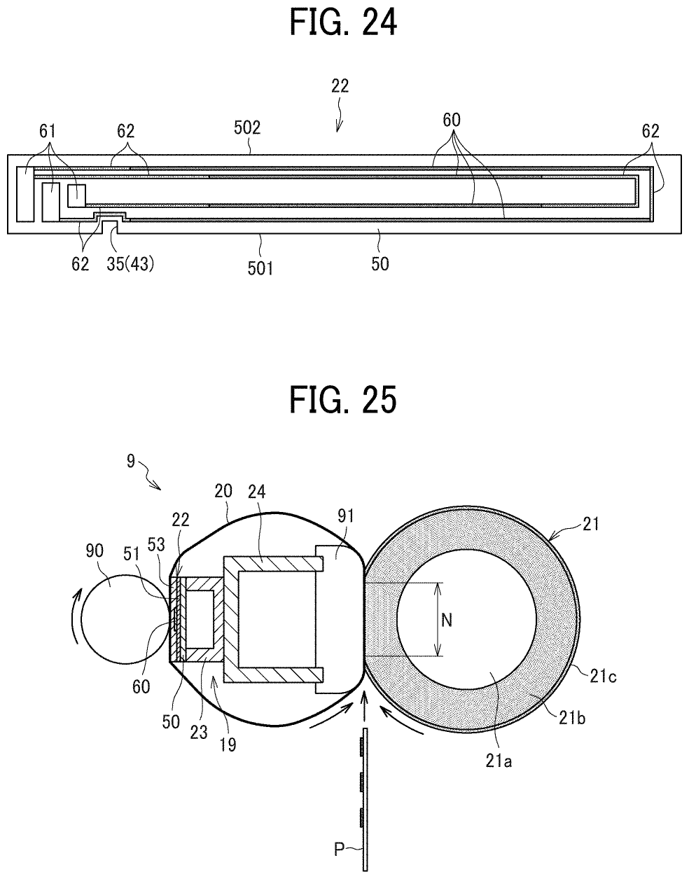

The connection of the heat generators 60 is not limited to the parallel connection and may instead be a serial connection as illustrated in FIG. 24.

The present disclosure is applicable to fixing devices illustrated in FIGS. 25 to 27 in addition to the above-described fixing devices. Referring now to FIGS. 25 to 27, a description is given of some variations of the fixing device 9.

First, the fixing device 9 illustrated in FIG. 25 includes a pressurization roller 90 opposite the pressure roller 21 with respect to the fixing belt 20 and heats the fixing belt 20 sandwiched by the pressurization roller 90 and the heater 22. On the other hand, a nip formation pad 91 serving as a nip former is disposed inside the loop formed by the fixing belt 20 and disposed opposite the pressure roller 21. The stay 24 supports the nip formation pad 91. The nip formation pad 91 and the pressure roller 21 sandwich the fixing belt 20 and define the fixing nip N.

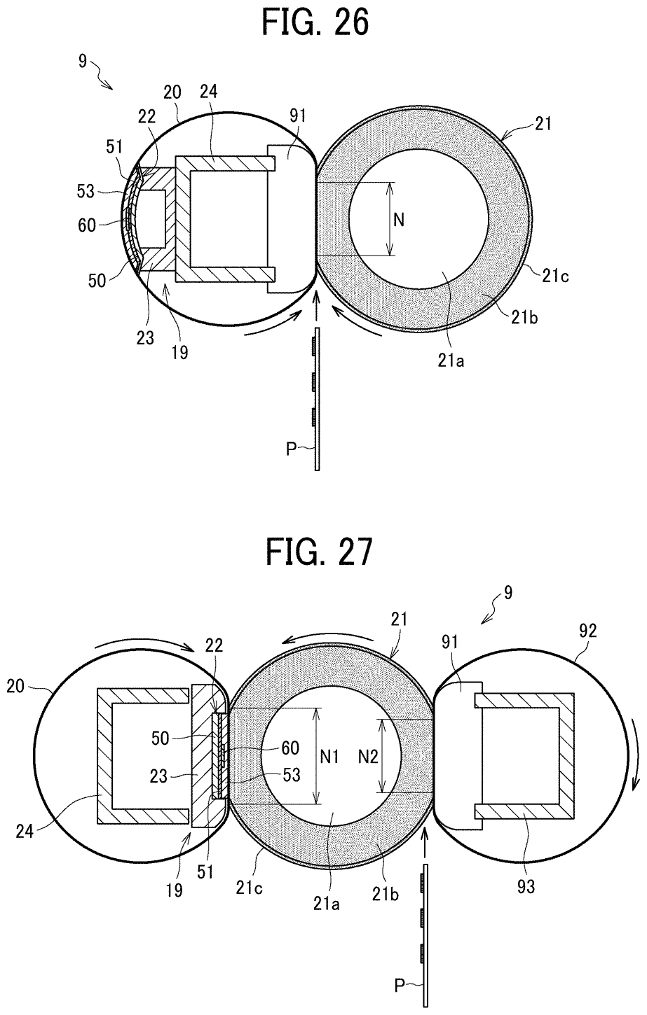

Next, the fixing device 9 illustrated in FIG. 26 is omitted the above described pressurization roller 90 and includes the heater 22 formed to be arc having a curvature of the fixing belt 20 to keep a circumferential contact length between the fixing belt 20 and the heater 22. The rest of the configuration of the fixing device illustrated in FIG. 25 is the same as the rest of the configuration of the fixing device 9 described above.

Lastly, the fixing device 9 illustrated in FIG. 27 includes a pressing belt 92 in addition to the fixing belt 20 and has a heating nip (a first nip) N1 and the fixing nip (a second nip) N2 separately. That is, the nip formation pad 91 and the stay 93 are disposed opposite the fixing belt 20 with respect to the pressure roller 21, and the pressing belt 92 is rotatably arranged to wrap around the nip formation pad 91 and the stay 93. The sheet P passes through the fixing nip N2 between the pressing belt 92 and the pressure roller 21 and is applied to heat and pressure, and the image is fixed on the sheet P. Other construction of the fixing device is equivalent to that of the fixing device 9 depicted in FIG. 2.

As described above, according to the present disclosure, arranging the positioner nearer to all the electrodes than the center of the base can reduce the variations in the positions of the electrodes caused by the thermal expansion and the thermal contraction in the base and abrasion at the contact part between the electrodes and the connector. As a result, the contact state between the electrodes and the connector can be favorably maintained for a long time, and the reliability is improved.

In particular, a great effect can be expected by applying the present disclosure to the fixing device like the above-described embodiment including the heater formed to be long corresponding to the sheet of A3 size or more, the heater including the base made of metal that thermally expands easily, or the heater including the heat generator having the PTC characteristic because the base of such a heater tends to have the large amount of the thermal expansion and thermal contraction due to temperature change. However, the present disclosure is not limited to the application to such a fixing device. Applying the present disclosure to the fixing device can reduce the variations in the positions of the electrodes caused by the thermal expansion and the thermal contraction in the base and abrasion at the contact part between the electrodes and the connector even when the fixing device includes the short heater corresponding to the sheet having smaller sizes than A3 size, the heater including the base made of ceramic, or the heater not having the PTC characteristic.

In addition to the above-described fixing device, a heating device according to the present disclosure is also applicable to a dryer to dry ink applied to the sheet and a heating device used in a coating device (a laminator) that heats, under pressure, a film serving as a covering member onto the surface of the sheet such as paper. The image forming apparatus 100 according to the embodiments of the present disclosure may be a copier, a facsimile machine, a multifunction peripheral (MFP) having at least two of copying, printing, scanning, facsimile, and plotter functions in addition to the printer. Embodiments of the present disclosure may be applied to an ink jet type image forming apparatus in addition to the electrophotographic type image forming apparatus.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A heating device comprising:
a heater including a base, a plurality of heat generators disposed on the base, and three or more electrodes disposed on the base and electrically connected to the heat generators;
a holder configured to hold the heater;
a positioner configured to position the heater with respect to the holder in a longitudinal direction of the heater, the positioner disposed closer to the electrodes than a center position of the base in a longitudinal direction of the base; and
a connector including a contact portion configured to contact the electrode.

2. The heating device according to claim 1,
wherein the positioner includes at least one of a recess disposed in the base, a through hole disposed in the base, and a projection disposed in the base.

3. The heating device according to claim 1,
wherein the electrodes are arranged in the longitudinal direction of the base.

4. The heating device according to claim 1,
wherein the electrodes on the base are aligned in a direction intersecting the longitudinal direction of the base.

5. The heating device according to claim 3,
wherein at least a part of the positioner is disposed inside a range in which the electrodes are arranged in the longitudinal direction of the base.

6. The heating device according to claim 3,
wherein the positioner is disposed at a position corresponding to a center of a range in which the electrodes are arranged in the longitudinal direction of the base.

7. The heating device according to claim 1,
wherein the heater includes a common power supply line configured to electrically connect all the heat generators to one of the electrodes, and
wherein the base includes a pair of edge portions extending in the longitudinal direction of the base, and
the positioner is disposed at one of the pair of edge portions that is farther from the common power supply line than the other of the pair of edge portions.

8. The heating device according to claim 1,
wherein the positioner is disposed at a position not overlapping a passage on the base over which the contact portion passes when the connector is attached to or detached from the heater.

9. The heating device according to claim 8,
wherein the positioner is disposed at a position that shifts from the passage of the contact portion in the longitudinal direction of the base.

10. The heating device according to claim 8,
wherein the base includes a pair of edge portions extending in the longitudinal direction of the base, and
the positioner is disposed at one of the pair of edge portions over which the contact portion does not pass when the connector is attached to or detached from the heater.

11. The heating device according to claim 1,
wherein the heat generators are arranged in the longitudinal direction of the base, and
two heat generators of the heat generators are electrically connected to a common electrode of the electrodes different from an electrode electrically connected to a heat generator disposed between the two heat generators.

12. A fixing device comprising:
a rotatable endless belt;
an opposed rotator configured to contact an outer circumferential surface of the belt and form a nip; and
the heating device according to claim 1 configured to heat the belt.

13. An image forming apparatus comprising:
an image forming device configured to form an image on a recording medium; and
the fixing device according to claim 12 configured to fix the image formed by the image forming device onto the recording medium.
